(19) United States
(12) Patent Application Publication
(10) Pub. No.: US 2022/0080812 A1
(43) Pub. Date: Mar. 17, 2022

(54) Roller blind web for a roller blind assembly in a vehicle, and process for manufacturing a roller blind web

(71) Applicant: Webasto SE, Stockdorf (DE)

(72) Inventors: Christian Sterl, Stockdorf (DE); Maren Schweizer, Stockdorf (DE)

(21) Appl. No.: 17/420,531

(22) PCT Filed: Dec. 3, 2019
(86) PCT No.: PCT/EP2019/083503

§ 371 Date: Jul. 2, 2021

(30) Foreign Application Priority Data
Jan. 30, 2019 (DE) 10 2019 102 339.4

(51) Int. Cl. B60J 1/20; B60J 7/00

(52) U.S. Cl. CPC B60J 1/2044; B33Y 80/00; B60J 7/0015

(57) ABSTRACT

A roller blind web for a roller blind arrangement of a vehicle. The roller blind web can be wound up or unwound along a pull-out direction and may have a roller blind material, and a functional element which is connected to the roller blind material. The functional element can produced by means of additive manufacturing and is constructed from a multiplicity of layers. A method is also provided.

The invention relates to a roller blind web for a roller blind arrangement of a vehicle, and also to a method for producing a roller blind web.

Roller blind arrangements (also known as shading apparatuses) having roller blind webs for use in a vehicle are known from the prior art. Such roller blind arrangements are used to protect against solar radiation under a transparent roof portion of the vehicle, for example under a sliding or panoramic roof of a vehicle roof. The roller blind web typically has one or more functional elements which are connected to the roller blind material. For example, the roller blind web has a pulling bow for actuation of the roller blind web. Such a roller blind arrangement is for example known from EP 1 006 012 A2.

It is desirable to specify a concept for a roller blind web which permits a particularly efficient and reliable production operation. It is also desirable to specify a method for producing such a roller blind web for a vehicle, said method being able to be carried out in a simple and variable manner.

According to a first aspect, a roller blind web for a roller blind arrangement of a vehicle is disclosed, wherein the roller blind web is formed so as to be able to be wound up or unwound along a pull-out direction. The roller blind web has a roller blind material. The roller blind material is for example a flexible element, in particular a flexible textile planar structure. The roller blind material is for example of grid-like configuration. The roller blind web has a functional element which is connected to the roller blind material. The functional element is produced by means of additive manufacturing and is constructed from a multiplicity of layers.

The functional element is for example a frame, a fastening element, a reinforcing element, a design element and/or a further attachment to the roller blind material or the roller blind web. As an alternative or in addition, the functional element is a connecting element for connection of a further textile element to the roller blind material, for example the functional element is connected to the further textile element by means of ultrasonic welding. The functional element is formed in particular from a plastic. The functional element is applied directly to the roller blind material by means of additive manufacturing. The additive manufacturing can also be referred to as 3D printing or generative manufacturing. The multiplicity of layers are applied in succession, for instance in a web-like manner, in order to form the functional element.

The construction of the functional element from the multiplicity of layers permits different properties for the functional element. In particular, various colors, shapes, cross sections, profiles or geometries are possible. The functional element can also be realized in different degrees of hardness.

Furthermore, it is possible to dispense with sewing processes. By way of example, folding over of the roller blind material to form a pocket and subsequent sewing of the pocket, into which a functional element produced in some other way is introduced, are omitted. The folding over of the material for a plurality of variants could be automated only with difficulty since it is for example possible for a sewn pocket for each variant to have different curvatures. The sewing would also require a large number of manual working steps, which can be implemented in fully automated fashion only with difficulty (or with great outlay). The sewing process is also a delicate process in which needle breakages, inhomogeneous thread tensions, weakening of the material, etc., have to be dealt with. The solution described makes it possible to manufacture and fasten a functional element in a threadless manner.

The use of additive manufacturing, for instance by means of an extruder, makes it possible to achieve very high printing rates in relation to the conventional FDM printing process (for example up to 1 m/s), as a result of which the functional element for the roller blind web requires merely a few seconds of printing time. It is also possible to use a granular material instead of filaments, which is considerably more favorable.

Furthermore, a particularly high degree of production flexibility is achieved in that different curvatures and welt lengths can be featured in different programs. It is possible to dispense with special tools. In addition, on account of the additive manufacturing, it is no longer necessary for functional elements to be finally cut to length or bought finally cut to length for the respective variant. This makes possible for example simpler warehousing, improved variant management and comparatively higher added value.

The additive manufacturing contributes to an effective and reliable production operation. Furthermore, a large degree of flexibility and simpler automatability are made possible. The functional element can thus be produced in a precise and cost-effective manner. This for example makes better mechanical properties possible. Furthermore, this results in an improved visual appearance of the functional element. The functional element can be manufactured rapidly by machine. In contrast to conventional functional elements, which are manufactured for example by means of injection-molding technology, the manufacturing costs can be reduced. The tool costs are lower, and the tool production duration can be reduced or avoided. It is also possible to achieve a higher degree of flexibility for example in the case of a change in the external dimensions of a functional element. The degrees of freedom in the construction are increased, since the required draft angles of injection-molding technology are omitted, for example. Damage to the roller blind material owing to burrs is avoided.

The manufacturing is carried out for example by means of a manufacturing installation which has a movable gantry with a printhead, for instance a nozzle or an extruder. By means of the printhead, material, for instance plastic, is applied in a layer-like manner to the roller blind material in order to form the functional element. The printhead can be moved relative to the roller blind material which is preferably deposited flatly. For this purpose, the printhead is mounted so as to be movable on the simply constructed gantry (also support or holding apparatus). The gantry has for example a movable carriage system. As an alternative, it is also possible for the roller blind material to be moved relative to the printhead. The printhead conveys the preferably liquid or viscous manufacturing material onto the roller blind material, for instance in the form of a plastics cord, a plastics track or a plastics strip, in each case in a plurality of plies or layers, which then cures. For this purpose, the printhead is coupled to a tank or material reserve for example by means of a hose connection. As an alternative, a type of storage container such as a hopper sits directly at or on the printhead. For the manufacture, a starting material can be melted during the manufacturing process, or it is already in a flowable state for the application.

The additive manufacturing of a functional element therefore makes a very simple and relatively mobile construction of a manufacturing installation possible. The manufacturing installation can be used in a flexible manner. High investment costs for differently configured roller blind webs are not necessary.

The roller blind web is configured for the use in a roller blind arrangement mentioned in the introduction. In addition to the roller blind web, a roller blind arrangement typically also comprises lateral guides for the roller blind web and at least one winding shaft, onto which the roller blind web can be wound or from which the roller blind web can be unwound. The roller blind web can be actuated between a rolled-up state and a maximally pulled-out, that is to say unrolled, state. Other constructions of roller blind arrangements with a roller blind web are also conceivable.

According to one embodiment, the functional element is produced by means of printing of the layers. The plastic or another material for production of the functional element is printed in a viscous form, for instance in the form of a paste or the like, and cures in the form of a layer. The multiplicity of layers are thus applied in succession. The functional element accordingly has a multiplicity of printed layers.

According to one embodiment, the functional element is connected to the roller blind material in a materially bonded manner by means of the adaptive manufacturing. In particular, a materially bonded and form-fitting connection is achieved. Due to the application of the plastic or other material in a liquid or viscous state, the roller blind material is impregnated and, as a result, a particularly good connection with respect to the roller blind material is formed. In other words, the material penetrates at least partially into the roller blind material. In the cured state, a material-to-material bond and form fit of the functional element with the roller blind material is thus achieved.

According to one embodiment, the functional element is configured in the form of a welt. A welt (keder) is configured for fastening to a welt rail or a pulling bow. A pulling bow typically has a welt. The welt is connected to the roller blind web in particular in an end region thereof and serves for fastening the roller blind web to the pulling bow.

According to one embodiment, the functional element is configured in the form of a lateral guide element which is arranged in a lateral edge region of the roller blind material. As such, the functional element extends laterally, parallel to the pull-out direction of the roller blind web, and serves to guide the roller blind web in guide rails or comparable elements of a roller blind arrangement.

According to one embodiment, the functional element is produced from a thermoplastic elastomer (TPE). As a result, the elasticity of the roller blind material in relation to a rigid material is only slightly restricted. A further advantage is that possible wrinkles, which can be produced as a result of shrinkage of the additively manufactured, for instance printed, welt, can be avoided in the assembled state.

According to one embodiment, an extent of the functional element perpendicular to a stacking direction of the layers varies. As indicated above, the shaping during the additive manufacturing can be varied virtually as desired. This variation does not relate to deviations owing to manufacturing tolerances. The stacking direction is understood to mean the direction along which the layers are arranged on top of one another. In other words, this means the direction of the layer sequence. As a result of the variation of the extent, it is for example possible to generate shapes which cannot readily be produced by means of other production techniques in a comparatively simple and cost-effective manner, for instance undercuts.

According to one embodiment, the roller blind web has a plurality of functional elements which are each connected to the roller blind material, are each produced by means of additive manufacturing and are each constructed from a multiplicity of layers. According to embodiments, functional elements are contiguous and/or configured in the form of non-contiguous functional elements. According to at least one embodiment, the functional elements have properties which differ relative to one another, at least in part. By way of example, the functional elements are configured differently to each other in terms of their outer shape, their hardness and/or their color. The plurality of functional elements are produced in particular by means of a single manufacturing process, for instance printing.

According to a second aspect, a method for producing a roller blind web for a roller blind arrangement of a vehicle is disclosed. The method comprises the following steps of:
providing a roller blind material,
additively applying a multiplicity of layers to the roller blind material, and as a result forming a functional element which is connected to the roller blind material. The functional element accordingly has a plurality of layers.

The advantages, features and developments of the roller blind web according to the first aspect also apply for the method and vice versa.

According to one embodiment, the application is performed under a pressure which is greater than atmospheric pressure. As a result, particularly good adhesion and penetration into the roller blind material is made possible. For example, a pressure between 2 and 30 bar has proven to be expedient.

According to one embodiment, the layers are applied by means of a nozzle at a small spacing from the roller blind material. As a result, particularly good adhesion and penetration into the roller blind material is made possible. For example, a spacing of 0.3 mm to 0.7 mm has proven to be expedient. Particularly preferably, the spacing is approximately 0.56 mm.

According to one embodiment, two roller blind materials, which are determined in each case for a roller blind web, are provided and arranged alongside one another. In the application step, the layers are applied in such a way that they extend across the two roller blind materials in the form of a web, such that on the two roller blind materials, at least in a respective portion of the web, a functional element is formed which has layers and which is connected to the respective roller blind material.

As a result, in a process step such as printing, two roller blind materials can be provided equally with functional elements, and thus two roller blind webs are generated equally. Subsequent machining steps may also follow, for instance in order to remove overhangs.

Further advantages, features and developments emerge from the subclaims and from the following examples which are elucidated in conjunction with the figures. Identical, similar and similarly acting elements can be provided with the same reference designations throughout the figures.

In the drawings:

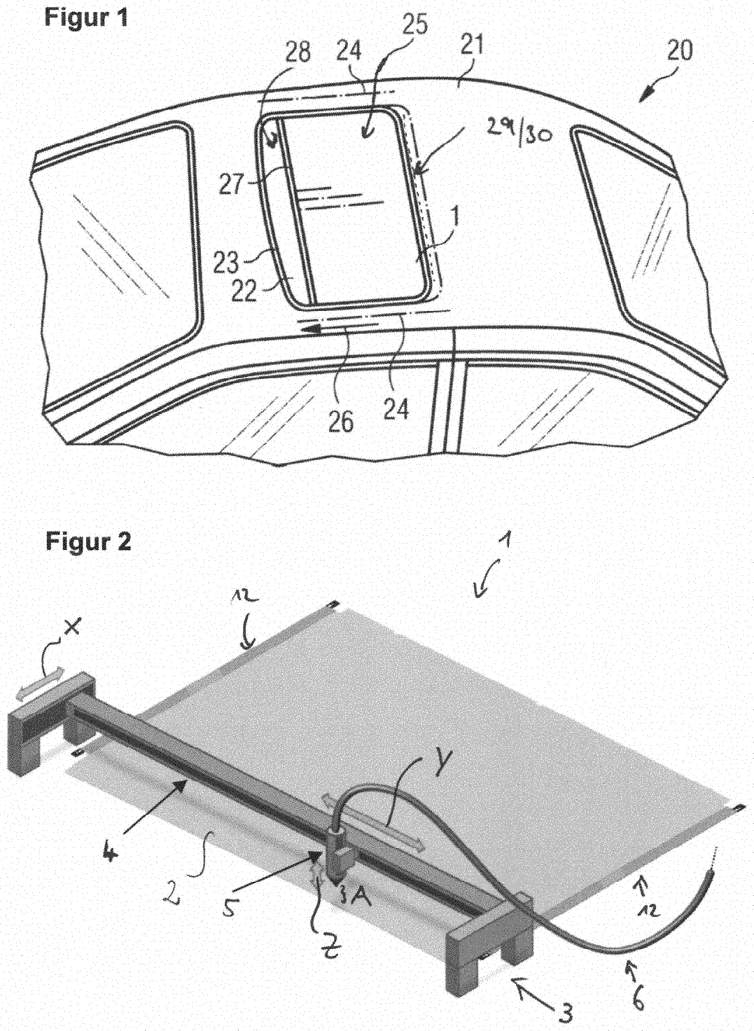

FIG. 1 shows a schematic, perspective view of a vehicle,

FIG. 2 shows a schematic, perspective illustration of a manufacturing installation during the manufacturing of a roller blind web according to one exemplary embodiment of the invention,

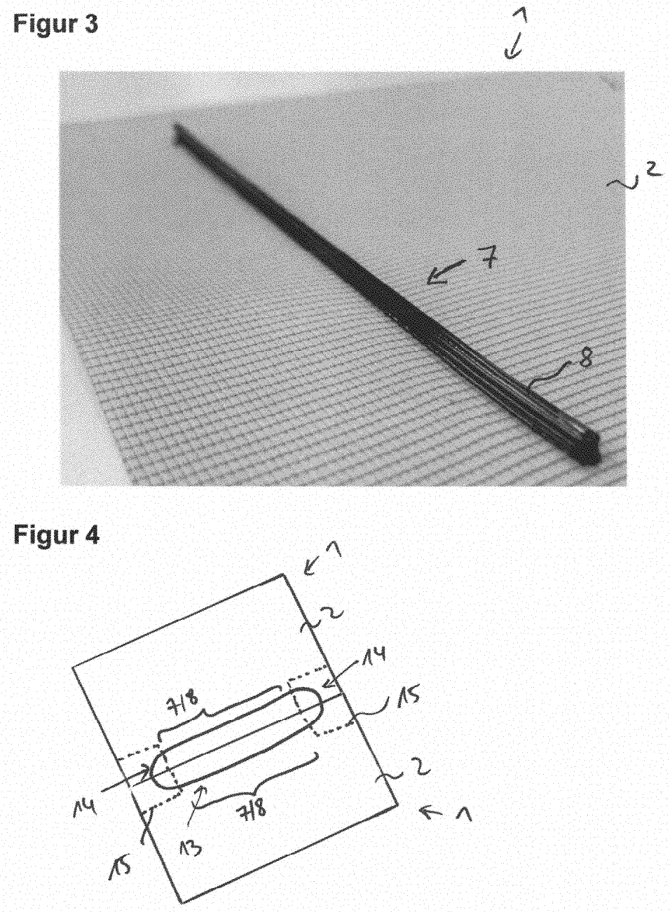

FIG. 3 shows a schematic, perspective illustration of a finished roller blind web according to one exemplary embodiment of the invention,

FIG. 4 shows a schematic illustration of a manufacturing operation of two roller blind webs according to one exemplary embodiment invention,

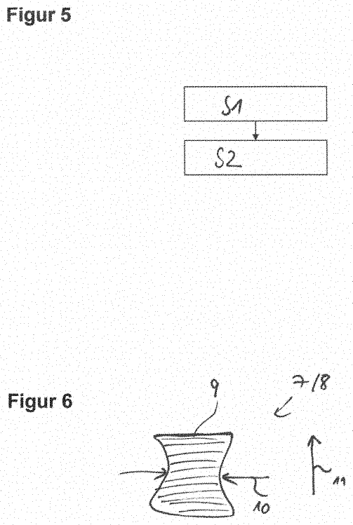

FIG. 5 shows a schematic flow diagram of a method for producing a roller blind web, and

FIG. 6 shows a schematic cross-sectional view of a welt of a roller blind web according to one exemplary embodiment of the invention.

FIG. 1 shows a schematic view of a vehicle 20, which has a vehicle roof 21 that is provided with a roof opening 22.

The vehicle roof 21 is fixedly coupled to the rest of a roof body. The roof opening 22 is selectively closable or at least partially openable by means of a displaceable sliding roof cover. As an alternative, the roof opening 22 is permanently closed by means of a transparent roof element, for instance a panoramic roof. In this case, a non-movable transparent roof element is provided. The roof opening 22 is bounded by a roof opening frame 23 which is formed on the vehicle roof 21. The roof opening frame 23 has guide rails 24 arranged on both sides. Arranged below the displaceable sliding roof cover is a shading apparatus 25. The shading apparatus 25 has a roller blind web 1. In a pull-out direction 26, the roller blind web 1 can be displaced toward the front and in the opposite direction toward the rear, such that the roller blind web 1 is wound up and unwound. The pull-out direction 26 runs substantially parallel to a longitudinal axis of the vehicle 20. The shading apparatus 25 is used to allow sunlight and ambient light into the vehicle 20 via the roof opening 22 or to prevent it from passing into the vehicle 20.

The roller blind web 1 is guided laterally in the guide rails 24 and extends between said guide rails at least during the winding-up and unwinding operations. The roller blind web 1 can be wound up completely at a rear end with respect to the pull-out direction 26. For this purpose, a winding apparatus 29 is for example provided, which has a winding shaft 30 (also known as a roller blind shaft). The two last-mentioned elements are indicated merely in dashed form. The roller blind web 1 is rolled up on the winding shaft 30 to form a roller blind winding. In order to actuate the roller blind web 1, a pulling bow 27 with a welt is provided at a front end 28 of the roller blind web 1, said pulling bow being provided for manually actuating the roller blind web 1. As an alternative, the roller blind web 1 or the pulling bow 27 can also be actuated automatically, for example via an electrical device.

It should be mentioned that the vehicle 20 described above and the shading apparatus 25 described are to be understood as exemplary and therefore can also be designed in some other way. The focus of the present disclosure lies substantially on the roller blind web 1 and the production thereof, which will be described below with reference to FIGS. 2 to 4 and 6 and to the schematic flow diagram of a production method according to FIG. 5. It should also be mentioned that the roller blind web 1 is also suitable for shading other windows in the vehicle.

FIG. 2 shows a roller blind web 1 which has a flexible, textile roller blind material 2. Furthermore, an exemplary manufacturing installation 3 is illustrated, which has a movable gantry 4 with an extruder 5 as printhead which is mounted movably or displaceably thereon. The extruder is movable in the X, Y and Z directions. As an alternative, provision can also be made of a movable machine bed which is moved relative to the positionally fixed extruder. The manufacturing installation 3 is configured to apply viscous plastics material in a layer-like manner to the roller blind material 2 by means of the extruder 5, in order to provide the roller blind material 2 with functional elements. The extruder 5 is supplied with plastics material by means of a hose or pipe connection 6. As an alternative, a storage container sits directly at or on the extruder 5, such that the material can be processed or used directly, without a hose connection.

The manufacturing installation 3 makes it possible for a functional element of the roller blind web 1 to be additively manufactured, during which a plurality of layers of a material are applied to the roller blind material 2 and thus a functional element with a plurality of layers is produced. An exemplary functional element 7 is shown in FIG. 3, said functional element being a welt 8 for a pulling bow. Said welt is connected directly and fixedly to the roller blind material 2 by way of the manufacturing method.

In a first step S1 of the production method, the roller blind material 2 is provided. The roller blind material 2 is laid ready in the form of a blank, which may already have its final dimensions. The roller blind material 2 may alternatively also be cut to its final shape at a later point in time.

In a next step S2, the functional element 7, in the example the welt 8, is printed directly onto the roller blind material 2 by additive application of a plurality of layers. In this case, viscous plastics material, for instance thermoplastic elastomer, is applied layer by layer by means of the extruder 5 of the manufacturing installation 3 and thereby cures. In this case, the liquid material is applied directly onto the roller blind material 2 under elevated pressure and with as small a spacing A as possible from said roller blind material. This method is also known as 3D printing. As a result, a particularly stable, in particular materially bonded and form-fitting connection to the roller blind material 2 is made possible. A further fastening of the welt 8 to the roller blind material 2 is not necessary.

In further steps, it is optionally also possible for subsequent machining operations to be carried out on the roller blind web 1 itself or the functional element 7.

By means of the additive method described and the layer-like construction generated thereby, the advantages and functions mentioned in the introduction are achieved. The functional element 7 can in particular be produced in a rapid and fully automated manner. It is thus possible for a simple and cost-effective production operation to be realized. Furthermore, the functional element 7 can be produced with different properties such as different colors, shapes and geometries.

FIG. 6 shows an exemplary welt 8. In the cross section shown, the welt 8 has a plurality of layers 9 (indicated in exemplary fashion). The extent 10 perpendicular to a stacking direction 11 is also varied.

By means of the described method, it is also possible for a plurality of functional elements to be produced, which are either contiguous or are applied to the roller blind material 2 separately from one another. For example, lateral guide elements can be manufactured in edge regions 12 of the roller blind web 1 in order to guide the roller blind web 1 in guide rails 24 (see FIG. 2).

FIG. 4 shows a further exemplary embodiment for manufacturing functional elements for two roller blind webs 1. For the production of functional elements 7 such as welts 8, two roller blind materials 2 are arranged alongside one another. In other words, said roller blind materials are laid “edge-to-edge” alongside one another. Subsequently, layers are additively applied in the form of a web 13 in a manufacturing operation. The web 13, which has a multiplicity of layers, extends across the two roller blind materials 2. In other words, the web 13 runs in a closed manner over the two roller blind materials 2. It is therefore not necessary for the extruder 5 to discontinue its action when printing the two elements. As a result, on the two roller blind materials 2, at least in a respective portion of the web 13, a functional element 7/8 is formed which has layers and which is fixedly connected to the respective roller blind material 2.

Overhangs 14, which are produced for example in the regions 15 indicated in dashed form during this manufacturing variant, can subsequently be removed. In these regions 15, it is optionally possible for protective elements such as films to be applied to the roller blind material 2 in order to prevent the material from adhering during application of the layers in that region.

As an alternative, the material track or web is also guided beyond the lateral edge of the roller blind materials 2, such that it is also possible to produce rectangular roller blind portions with a functional element extending over the entire length. The deflection and the overhangs 14 then lie outside of the roller blind materials 2 or the roller blind webs and can optionally rest on protective elements. The overhangs 14 are again removed.

### REFERENCE DESIGNATIONS

1 Roller blind web
2 Roller blind material
3 Manufacturing installation
4 Gantry
5 Extruder
6 Hose connection
7 Functional element
8 Welt
9 Layer
10 Extent
11 Stacking direction
12 Edge region
13 Web
14 Overhang
15 Region
20 Vehicle
21 Vehicle roof
22 Roof opening
23 Roof opening system
24 Guide rail
25 Shading apparatus
26 Pull-out direction
27 Pulling bow
28 Front end
29 Winding apparatus
30 Winding shaft
A Spacing
S1-S Steps
X Direction
Y Direction
Z Direction

1. A roller blind web for a roller blind arrangement of a vehicle, wherein the roller blind web can be wound up or unwound along a pull-out direction and has:
a roller blind material, and
a functional element which is connected to the roller blind material, wherein the functional element is produced by means of additive manufacturing and is constructed from a multiplicity of layers.

2. The roller blind web according to claim 1, wherein the functional element is produced by means of printing of the layers.

3. The roller blind web according to claim 1, wherein the functional element is connected to the roller blind material in a materially bonded manner by means of the adaptive manufacturing.

4. The roller blind web according to claim 1, wherein the functional element is configured in the form of a welt.

5. The roller blind web according to claim 1, wherein the functional element is configured in the form of a lateral guide element which is arranged in an edge region of the roller blind material.

6. The roller blind web according to claim 1, wherein the functional element is formed from plastics layers.

7. The roller blind web according to claim 6, wherein the functional element is produced from a thermoplastic elastomer.

8. The roller blind web according to claim 1, wherein an extent of the functional element perpendicular to a stacking direction of the layers varies.

9. The roller blind web according to claim 1, having a plurality of functional elements which are each connected to the roller blind material, are each produced by means of additive manufacturing and are each constructed from a multiplicity of layers.

10. A method for producing a roller blind web for a roller blind arrangement of a vehicle, comprising:
providing a roller blind material,
additively applying a multiplicity of layers to the roller blind material, and as a result forming a functional element which is connected to the roller blind material.

11. The method according to claim 10, wherein the application comprises printing the layers.

12. The method according to claim 10, wherein, in the step of applying the multiplicity of layers, the functional element is connected to the roller blind material in a materially bonded manner.

13. The method according to claim 10, wherein the application is performed under a pressure which is greater than atmospheric pressure.

14. The method according to claim 10, wherein the layers are applied by means of a nozzle at a small spacing from the roller blind material.

15. The method according to claim 9, wherein the layers are applied in such a way that an extent of the functional element perpendicular to a stacking direction of the layers varies.

16. The method according claim 9, wherein, in the application step, a plurality of functional elements are formed, which each have a plurality of layers and are connected to the roller blind material.

17. The method according to claim 9, wherein
two roller blind materials are provided and arranged alongside one another, and,
in the application step, the layers are applied in such a way that they extend across the two roller blind materials in the form of a web, such that on the two roller blind materials, at least in a respective portion of the web, a functional element is formed which has layers and which is connected to the respective roller blind material.
